(19) United States
(12) Patent Application Publication
(10) Pub. No.: US 2025/0353545 A1
(43) Pub. Date: Nov. 20, 2025

(54) SYSTEMS AND METHODS FOR OPTIMIZED POSITION CONTROL USING FRICTION FEEDFORWARD COMPENSATION

(71) Applicant: STEERING SOLUTIONS IP HOLDING CORPORATION, Saginaw, MI (US)

(72) Inventors: Xinfu Xu, Jiangsu (CN); Lingxia Zhou, Jiangsu (CN)

(21) Appl. No.: 18/739,934

(22) Filed: Jun. 11, 2024

(30) Foreign Application Priority Data
May 14, 2024 (CN) 2024105982397

(51) Int. Cl. B62D 5/22; B60W 10/20; B60W 50/00; B62D 5/04; B62D 15/02

(52) U.S. Cl. CPC B62D 5/22; B60W 10/20; B60W 50/00; B62D 5/0496; B62D 15/021; B60W 2050/0011; B60W 2540/18

(57) ABSTRACT

A method for steering system position control includes receiving a target angle for a pinion of a rack of a steering system, receiving an actual angle of the pinion, and determining an angle error value based on a difference between the target angle and the actual angle. The method also includes providing the angle error value to a proportional-integral-derivative (PID) controller, receiving a target velocity of the pinion, and generating a friction compensation value based on the target velocity. The method also includes generating a control command value based on an output of the PID controller and the friction compensation value, and controlling at least one aspect of the steering system based on the control command value.

### CROSS-REFERENCES TO RELATED APPLICATIONS

This US Utility patent application claims priority to Chinese Patent Application Serial No. 2024105982397, filed May 14, 2024, which is incorporated herein by reference in its entirety.

### TECHNICAL FIELD

This disclosure relates to steering systems, and in particular, to systems and methods for optimized position control using friction feedforward compensation.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a method for steering system position control. The method includes receiving a target angle for a pinion of a rack of a steering system, receiving an actual angle of the pinion, and determining an angle error value based on a difference between the target angle and the actual angle. The method also includes providing the angle error value to a proportional-integral-derivative (PID) controller, receiving a target velocity of the pinion, and generating a friction compensation value based on the target velocity. The method also includes generating a control command value based on an output of the PID controller and the friction compensation value, and controlling at least one aspect of the steering system based on the control command value.

Another aspect of the disclosed embodiments includes a system for steering system position control. The system includes a processor, and a memory. The memory includes instructions that, when executed by the processor, cause the processor to: receive a target angle for a pinion of a rack of a steering system; receive an actual angle of the pinion; determine an angle error value based on a difference between the target angle and the actual angle; provide the angle error value to a proportional-integral-derivative (PID) controller; receive a target velocity of the pinion; generate a friction compensation value based on the target velocity; generate a control command value based on an output of the PID controller and the friction compensation value; and control at least one aspect of the steering system based on the control command value.

Another aspect of the disclosed embodiments includes an apparatus for steering system position control. The apparatus includes a controller configured to: receive a target angle for a pinion of a rack of an electronic power steering system; receive an actual angle of the pinion; determine an angle error value based on a difference between the target angle and the actual angle; provide the angle error value to a proportional-integral-derivative (PID) controller; receive a target velocity of the pinion; determine a temperature scale factor based on at least one temperature value; generate a friction compensation value based on the target velocity and the at least one temperature value; generate a control command value based on a sum of an output of the PID controller and the friction compensation value; and control at least one aspect of the electronic power steering system based on the control command value.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIG. 3 generally illustrates plot of adaptive cruise control angle tracking error according to the principles of the present disclosure.

FIG. 4A is a block diagram of a friction compensation algorithm according to the principles of the present disclosure.

FIG. 4B generally illustrates Lurge friction model according to the principles of the present disclosure.

FIG. 4C is a block diagram of an alternative friction compensation algorithm according to the principles of the present disclosure.

FIG. 5 is a flow diagram generally illustrating a friction compensation method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

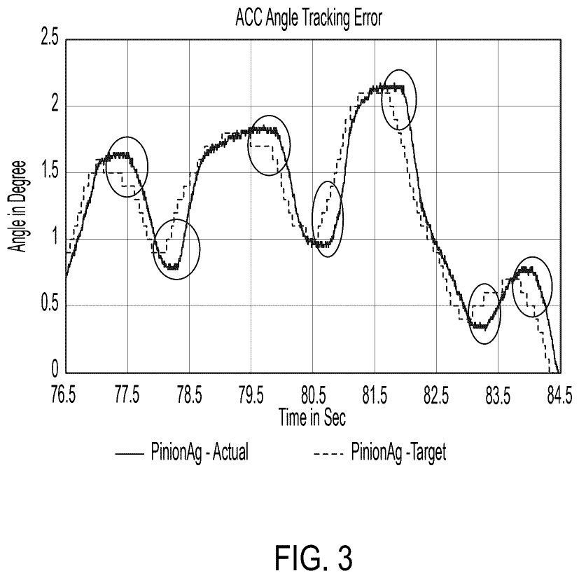

Typically, for EPS advanced driver assistances system (ADAS) features using angle overlay, a proportion-integral-derivative (PID) controller is used for angle tracking control. Due to the hysteresis in the controlled plant (e.g., the gear and tire and/or road), as is generally illustrated in FIG. 3, tracking errors increase at reverse (e.g., this is especially true for small range on-center angle tracking logics, such as lane keep assist (LKA), lane center keep (LCK) or adaptive cruise control (ACC)).

Such systems typically calculate rack load, which is composed by vehicle self-aligning torque, rack inertia, damping and friction forces. The associated assist torque for steering towards end of travel is defined as:

$$Assist Torque = self aligning torque + rack inertia + rack damping + friction force$$

The associated assist torque for steering towards center is defined as:

$$Assist Torque = self aligning torque - ( rack inertia + rack damping + friction force )$$

Due to the rack inertia and damping, and the friction force, there is a hysteresis in the system, and, as a result, the reverse delay of PID controller is induced.

Accordingly, systems and methods, such as those described herein, configured to provide improved position control for steering systems, may be desirable. In some embodiments, the systems and methods described herein may be configured to add a friction compensation-based feedforward component to a PID controller. The systems and methods described herein may be configured to generate a friction compensation command using the target pinion velocity. The systems and methods described herein may be configured to mimic a Lugre model of friction.

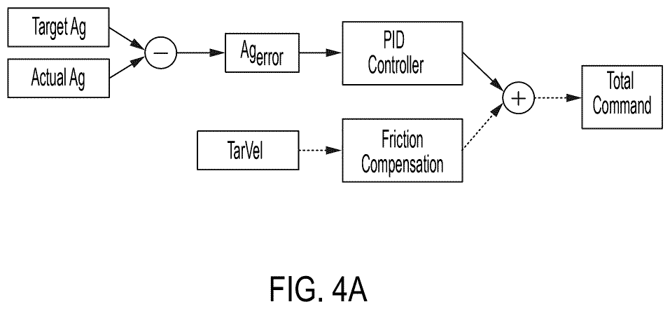

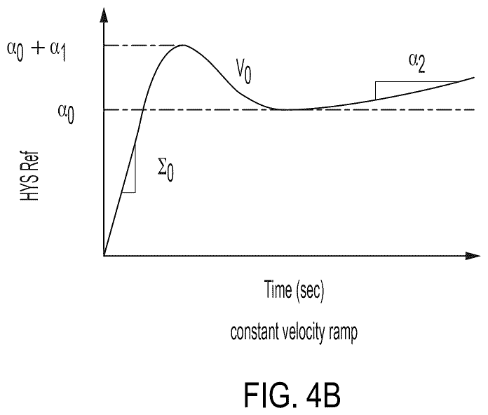

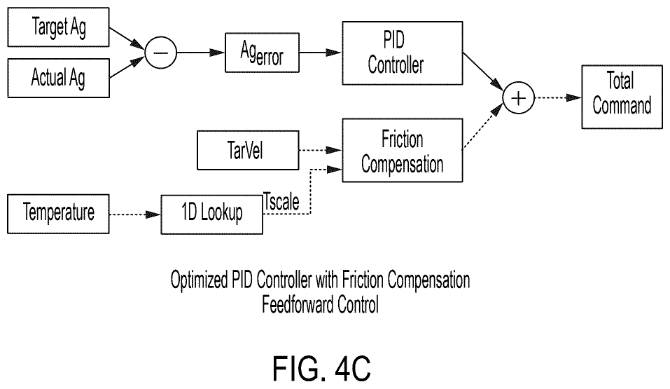

With reference to FIG. 4, with an optimized PID controller, the friction compensation is used at reverse, and/or for the time delay at reverse, and the PID controller compensates, otherwise. As a result, the reverse delay will be greatly reduced.

The systems and methods described herein may be configured to use a friction model, such as the Lugre model of friction generally illustrated in FIG. 4B. The friction model may be defined according to:
α₀, α₁, α₂, Σ₀ and Σ₁ are HwPos Dependent and VehSpd bilinear lookup values.
V₀, V_{d} are VehSpd dependent 1-D lookup values.

$$HysTqRefRaw = {Σ}_{0} * z * {Σ}_{0} Scaling + {Σ}_{1} v * dz + {α}_{2} * v \\ z = \frac{( 2 - T v * 0.002 ) * {Z}_{\_ 1} + ( v + {v}_{\_ 1} ) * 0.002}{2 + T v * 0.002} \\ Tv = \frac{{Σ}_{0} * \vert v \vert}{g v} or TLmt \\ dz = v - T v * z \\ {Σ}_{0} Scaling = \frac{TLmt * gv}{{Σ}_{0} * \vert v \vert} or 1 \\ {Σ}_{1} v = \frac{{Σ}_{1} * v}{{V}_{d}} \\ gv = {α}_{0} + \frac{{α}_{0} * v}{{V}_{0}}$$

In some embodiments, as is generally illustrated in FIG. 4C, the systems and methods described herein may be configured to use a temperature scale. For example, because system friction changes with temperature, the systems and methods described herein may be configured to add a temperature dependent scale factor to scale the Coulomb friction portion (α₀) of the Lugre friction model. The systems and methods described herein may be configured to use an estimated temperature associated with an assist mechanism for column-assist EPS (CEPS) or an estimated temperature associated with a ball nut for rack-assist EPS (REPS).

The system friction and/or friction compensation feedforward acts as a disturbance to the PID controller. With adequate calibration of the scale factor, positive effect of the compensation may outweigh any side effect (e.g., even with the compensated value being different from the actual required compensation).

The systems and methods described herein may be configured to improve position tracking performance at reverse using the friction compensation feedforward component described herein.

The systems and methods described herein may be configured to add a friction feedforward compensation to the closed loop position tracking control of the EPS steering system to optimize the tracking performance at reverse, especially at an on-center area.

In some embodiments, the systems and methods described herein may be configured to receive a target angle for a pinion of a rack of a steering system. The systems and methods described herein may be configured to receive an actual angle of the pinion. The actual angle may correspond to measurement data of a sensor associated with the pinion and/or any other suitable measurement associated with any other aspect of the steering system. The systems and methods described herein may be configured to determine an angle error value based on a difference between the target angle and the actual angle.

The systems and methods described herein may be configured to provide the angle error value to a PID controller. The systems and methods described herein may be configured to receive a target velocity of the pinion. The systems and methods described herein may be configured to generate a friction compensation value based on the target velocity. For example, the systems and methods described herein may be configured to generate the friction compensation value based on the target velocity using a Lugre model of friction.

In some embodiments, the systems and methods described herein may be configured to receive at least one temperature value. In some embodiments, the steering system may include a column-assist electronic power steering system and the at least one temperature measurement value may correspond to an estimated temperature associated with an assist mechanism of the column-assist electronic power steering system. Additionally, or alternatively, the steering system may include a rack-assist electronic power steering system, and the at least one temperature measurement value may correspond to an estimated temperature associated with a ball nut of the rack-assist electronic power steering system.

The systems and methods described herein may be configured to determine a temperature scale factor based on the at least one temperature value. For example, the systems and methods described herein may be configured to determine the temperature scale factor using a one-dimensional lookup table that correlates temperature values to temperature scale factors. The systems and methods described herein may be configured to adjust the friction compensation value based on the temperature scale factor. For example, the systems and methods described herein may be configured to adjust the friction compensation value based on the temperature scale factor by adding the temperature scale factor to the friction compensation value.

The systems and methods described herein may be configured to generate a control command value based on an output of the PID controller and the friction compensation value. For example, the systems and methods described herein may be configured to generate the control command by adding the friction compensation value to the output of the PID controller. The systems and methods described herein may be configured to control at least one aspect of the steering system based on the control command value.

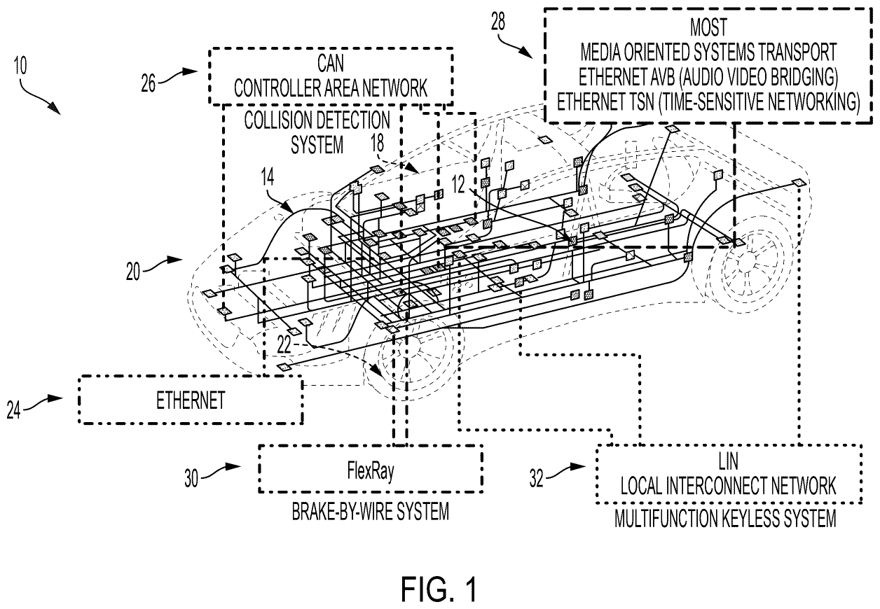

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by a operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

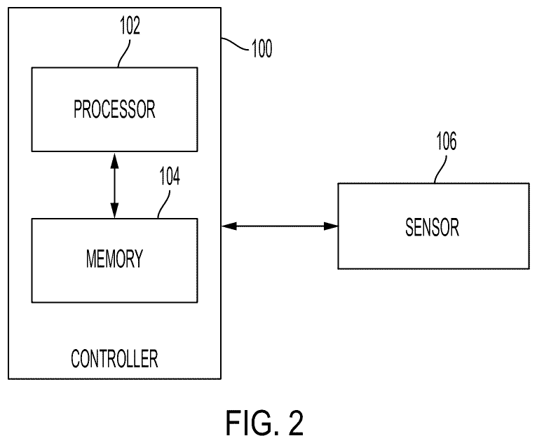

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to provide friction compensation for the steering system of the vehicle 10. For example, the controller 100 may receive a target angle for a pinion of a rack of the steering system. The controller 100 may receive an actual angle of the pinion. The actual angle may correspond to measurement data of a sensor 106 associated with the pinion and/or any other suitable measurement associated with any other aspect of the steering system. The controller 100 may determine an angle error value based on a difference between the target angle and the actual angle.

The controller 100 may provide the angle error value to a PID controller. The controller 100 may receive a target velocity of the pinion. The controller 100 may generate a friction compensation value based on the target velocity. For example, the controller 100 may generate the friction compensation value based on the target velocity using a Lugre model of friction.

In some embodiments, the controller 100 may receive at least one temperature value. The controller 100 may determine a temperature scale factor based on the at least one temperature value. For example, the controller 100 may determine the temperature scale factor using a one-dimensional lookup table that correlates temperature values to temperature scale factors. The controller 100 may adjust the friction compensation value based on the temperature scale factor. For example, the controller 100 may adjust the friction compensation value based on the temperature scale factor by adding the temperature scale factor to the friction compensation value.

The controller 100 may generate a control command value based on an output of the PID controller and the friction compensation value. For example, the controller 100 may generate the control command by adding the friction compensation value to the output of the PID controller. The controller 100 may control at least one aspect of the steering system based on the control command value.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

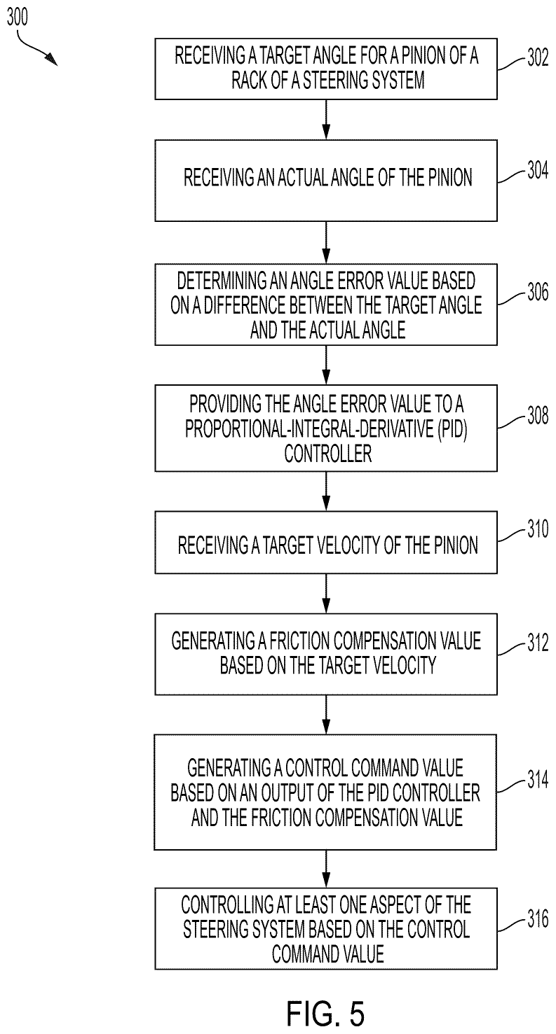

FIG. 5 is a flow diagram generally illustrating a friction compensation method 300 according to the principles of the present disclosure. At 302, the method 300 receives a target angle for a pinion of a rack of a steering system.

At 304, the method 300 receives an actual angle of the pinion.

At 306, the method 300 determines an angle error value based on a difference between the target angle and the actual angle.

At 308, the method 300 provides the angle error value to a PID controller.

At 310, the method 300 receives a target velocity of the pinion.

At 312, the method 300 generates a friction compensation value based on the target velocity. Additionally, or alternatively, the method 300 may generate the friction compensation value based on temperature. Additionally, or alternatively, the method 300 may generate the friction compensation value based on one or more of the target velocity and the temperature.

At 314, the method 300 generates a control command value based on an output of the PID controller and the friction compensation value.

At 316, the method 300 controls at least one aspect of the steering system based on the control command value.

In some embodiments, a method for steering system position control includes receiving a target angle for a pinion of a rack of a steering system, receiving an actual angle of the pinion, and determining an angle error value based on a difference between the target angle and the actual angle. The method also includes providing the angle error value to a proportional-integral-derivative (PID) controller, receiving a target velocity of the pinion, and generating a friction compensation value based on the target velocity. The method also includes generating a control command value based on an output of the PID controller and the friction compensation value, and controlling at least one aspect of the steering system based on the control command value.

In some embodiments, generating the control command value based on the output of the PID controller and the friction compensation value includes adding the friction compensation value to the output of the PID controller. In some embodiments, generating the friction compensation value based on the target velocity includes using a Lugre model of friction. In some embodiments, the actual angle corresponds to measurement data of a sensor associated with the pinion. In some embodiments, the method also includes receiving at least one temperature value. In some embodiments, the steering system includes a column-assist electronic power steering system, and wherein the at least one temperature measurement value corresponds to an estimated temperature associated with an assist mechanism of the column-assist electronic power steering system. In some embodiments, the steering system includes a rack-assist electronic power steering system, and wherein the at least one temperature measurement value corresponds to an estimated temperature associated with a ball nut of the rack-assist electronic power steering system. In some embodiments, the method also includes determining a temperature scale factor based on the at least one temperature value. In some embodiments, determining the temperature scale factor based on the at least one temperature value includes using a one-dimensional lookup table that correlates temperature values to temperature scale factors. In some embodiments, the method also includes adjusting the friction compensation value based on the temperature scale factor. In some embodiments, adjusting the friction compensation value based on the temperature scale factor includes adding the temperature scale factor to the friction compensation value.

In some embodiments, a system for steering system position control includes a processor, and a memory. The memory includes instructions that, when executed by the processor, cause the processor to: receive a target angle for a pinion of a rack of a steering system; receive an actual angle of the pinion; determine an angle error value based on a difference between the target angle and the actual angle; provide the angle error value to a proportional-integral-derivative (PID) controller; receive a target velocity of the pinion; generate a friction compensation value based on the target velocity; generate a control command value based on an output of the PID controller and the friction compensation value; and control at least one aspect of the steering system based on the control command value.

In some embodiments, the instructions further cause the processor to generate the control command value based on the output of the PID controller and the friction compensation value by adding the friction compensation value to the output of the PID controller. In some embodiments, generating the friction compensation value based on the target velocity includes using a Lugre model of friction. In some embodiments, the instructions further cause the processor to receive at least one temperature value. In some embodiments, the steering system includes a column-assist electronic power steering system, and wherein the at least one temperature measurement value corresponds to an estimated temperature associated with an assist mechanism of the column-assist electronic power steering system. In some embodiments, the steering system includes a rack-assist electronic power steering system, and wherein the at least one temperature measurement value corresponds to an estimated temperature associated with a ball nut of the rack-assist electronic power steering system. In some embodiments, the instructions further cause the processor to determine a temperature scale factor based on the at least one temperature value. In some embodiments, the instructions further cause the processor to adjust the friction compensation value based on the temperature scale factor.

In some embodiments, an apparatus for steering system position control includes a controller configured to: receive a target angle for a pinion of a rack of an electronic power steering system; receive an actual angle of the pinion; determine an angle error value based on a difference between the target angle and the actual angle; provide the angle error value to a proportional-integral-derivative (PID) controller; receive a target velocity of the pinion; determine a temperature scale factor based on at least one temperature value; generate a friction compensation value based on the target velocity and the at least one temperature value; generate a control command value based on a sum of an output of the PID controller and the friction compensation value; and control at least one aspect of the electronic power steering system based on the control command value.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method for steering system position control, the method comprising:
receiving a target angle for a pinion of a rack of a steering system;
receiving an actual angle of the pinion;
determining an angle error value based on a difference between the target angle and the actual angle;
providing the angle error value to a proportional-integral-derivative (PID) controller;
receiving a target velocity of the pinion;
generating a friction compensation value based on the target velocity;
generating a control command value based on an output of the PID controller and the friction compensation value; and
controlling at least one aspect of the steering system based on the control command value.

2. The method of claim 1, wherein generating the control command value based on the output of the PID controller and the friction compensation value includes adding the friction compensation value to the output of the PID controller.

3. The method of claim 1, wherein generating the friction compensation value based on the target velocity includes using a Lugre model of friction.

4. The method of claim 1, wherein the actual angle corresponds to measurement data of a sensor associated with the pinion.

5. The method of claim 1, further comprising receiving at least one temperature value.

6. The method of claim 5, wherein the steering system includes a column-assist electronic power steering system, and wherein the at least one temperature measurement value corresponds to an estimated temperature associated with an assist mechanism of the column-assist electronic power steering system.

7. The method of claim 5, wherein the steering system includes a rack-assist electronic power steering system, and wherein the at least one temperature measurement value corresponds to an estimated temperature associated with a ball nut of the rack-assist electronic power steering system.

8. The method of claim 5, further comprising determining a temperature scale factor based on the at least one temperature value.

9. The method of claim 8, wherein determining the temperature scale factor based on the at least one temperature value includes using a one-dimensional lookup table that correlates temperature values to temperature scale factors.

10. The method of claim 8, further comprising adjusting the friction compensation value based on the temperature scale factor.

11. The method of claim 10, wherein adjusting the friction compensation value based on the temperature scale factor includes adding the temperature scale factor to the friction compensation value.

12. A system for steering system position control, the system comprising:
a processor; and
a memory including instructions that, when executed by the processor, cause the processor to:
receive a target angle for a pinion of a rack of a steering system;
receive an actual angle of the pinion;
determine an angle error value based on a difference between the target angle and the actual angle;
provide the angle error value to a proportional-integral-derivative (PID) controller;
receive a target velocity of the pinion;
generate a friction compensation value based on the target velocity;
generate a control command value based on an output of the PID controller and the friction compensation value; and
control at least one aspect of the steering system based on the control command value.

13. The system of claim 12, wherein the instructions further cause the processor to generate the control command value based on the output of the PID controller and the friction compensation value by adding the friction compensation value to the output of the PID controller.

14. The system of claim 12, wherein generating the friction compensation value based on the target velocity includes using a Lugre model of friction.

15. The system of claim 12, wherein the instructions further cause the processor to receive at least one temperature value.

16. The system of claim 15, wherein the steering system includes a column-assist electronic power steering system, and wherein the at least one temperature measurement value corresponds to an estimated temperature associated with an assist mechanism of the column-assist electronic power steering system.

17. The system of claim 15, wherein the steering system includes a rack-assist electronic power steering system, and wherein the at least one temperature measurement value corresponds to an estimated temperature associated with a ball nut of the rack-assist electronic power steering system.

18. The system of claim 15, wherein the instructions further cause the processor to determine a temperature scale factor based on the at least one temperature value.

19. The system of claim 18, wherein the instructions further cause the processor to adjust the friction compensation value based on the temperature scale factor.

20. An apparatus for steering system position control, the apparatus comprising:
a controller configured to:
receive a target angle for a pinion of a rack of an electronic power steering system;
receive an actual angle of the pinion;
determine an angle error value based on a difference between the target angle and the actual angle;
provide the angle error value to a proportional-integral-derivative (PID) controller;
receive a target velocity of the pinion;
determine a temperature scale factor based on at least one temperature value;
generate a friction compensation value based on the target velocity and the at least one temperature value;
generate a control command value based on a sum of an output of the PID controller and the friction compensation value; and
control at least one aspect of the electronic power steering system based on the control command value.
